(19) United States
(12) Patent Application Publication
(10) Pub. No.: US 2003/0183683 A1
(43) Pub. Date: Oct. 2, 2003

(54) Method and associated system for specimen and sample chain of custody tracking

(76) Inventor: David J. Stewart, Southington, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/396,237

(22) Filed: Mar. 25, 2003

Related U.S. Application Data
(60) Provisional application No. 60/369,103, filed on Mar. 28, 2002.

(51) Int. Cl. G06F 7/00

(52) U.S. Cl. 235/376; 604/317

(57) ABSTRACT

Sample specimens such as biological samples are collected from the donor at a collection site and transferred to a transport container which includes RFID medium for carrying the chain of custody information generated at the collection site. The electronic signature of the donor and/or collector is captured to verify the chain of custody information and is included in the RFID medium record. Tamper-evident medium is used to insure the integrity of the sample specimen. The RFID medium may be separated from the container and recycled for subsequent use.

### TECHNICAL FIELD

The present invention relates generally to specimen and sample chain of custody tracking in the medical, health and insurance industries and deals more particularly with a method and associated system for paperless chain of custody tracking and processing of human sample specimens using RFID (Radio Frequency Identification).

### BACKGROUND OF THE INVENTION

It is commonly known to collect various biological samples such as whole blood, urine specimens, saliva, human tissue and the like in a container or tube for subsequent analysis and testing. Various systems have been proposed to identify the collected sample specimen for tracking purposes in an attempt to insure that the collected sample specimen is associated with the corresponding correct donor. Chain of Custody (COC) forms such as multi-layer paper forms or other such forms commonly known by those skilled in the art are used to track samples, particularly specimens for urine testing for drugs of abuse, blood and human tissue testing and/or sampling. A sample specimen tracked with such COC forms is susceptible to error because the form may be misplaced or otherwise become disassociated with the container holding the sample specimen and mistakenly associated with another container carrying a different sample.

Another disadvantage of known sample specimen chain of custody tracking systems is the inability to insure the integrity and validity of the information entered onto the COC form because the information may be altered after the fact or after a given task has been completed for example, the identity of one collector can be replaced by the identity of another different collector or the donor information may be changed or altered.

A further disadvantage is tracked sample specimens may be susceptible to fraud because the information on the forms may be manipulated or executed by others at times and locations other than the actual collection, transporting and testing times and locations.

Further, the COC forms can be “doctored” to cover up tampering with or substitution of the collected sample specimen with another sample specimen. Although tamper-evident containers are known, the information on the COC forms can still be altered.

A still further disadvantage associated with specimen COC tracking forms is the generally limited space for relevant data entry and therefore retrieval from and correlation of data from multiple sources may be required further leading to possible errors, inaccuracies and fraudulent information associated with the sample specimen being tracked.

Accordingly there is a need to provide a specimen and sample chain of custody tracking system and method that overcomes the problems generally associated with paper chain of custody (COC) forms specimen and sample tracking.

It is known to use Radio Frequency Identification (RFID) technology and RFID systems for identification and/or tracking of equipment or inventory such as pallets, trucks, boxes, packages, mail or even the whereabouts of pets/animals and livestock. In general, RFID medium is capable of retaining and, in operation, transmitting a substantial amount of information to uniquely identify individuals, packages, inventory, and the like. RFID systems are radio communication systems in which communication is provided between a radio transceiver, or antenna/interrogator, and an RFID medium. Typically, the user simply holds or places the RFID medium near a base station that transmits an excitation signal to the RFID medium powering circuitry contained within the RFID medium. The circuitry, responsive to the excitation signal, communicates the stored information from the RFID medium to the base station, which receives and decodes the information. The RFID medium may take on various forms and typically are in the form of small, identifying labels such as tags or chips. The reader is referred to textbooks and literature in the art for further details and explanation of the operation of RFID technology and RFID medium. RFID technology and RFID systems provide a reliable and secure architecture that is well suited for use in the present invention to implement a paperless chain of custody (COC) tracking of sample specimens.

### SUMMARY OF THE INVENTION

In accordance with a first aspect of the invention, a method for specimen and sample chain of custody tracking is presented. A desired sample specimen is collected from a donor at a collection site and is placed in a transport container that is uniquely identified through information associated with or stored in an RFID medium such as an RFID tag or chip. The chain of custody information is generated and written to the RFID medium. The chain of custody information is read from the RFID medium at a laboratory/testing site and the collected sample specimen is processed in accordance with the laboratory/testing site standard operating procedures. The chain of custody information is then erased or removed from the RFID medium.

Preferably, the step of writing the chain of custody information includes the step of writing the donor's electronic signature to the RFID medium verifying the chain of custody information.

Preferably, the step of writing the chain of custody information includes the step of writing the collector's electronic signature to the RFID medium.

Preferably, the method includes the step of affixing the RFID medium to the transport container.

Preferably, the method includes the step of providing a tamper-evident detection means to the RFID medium.

Preferably, the method includes the step generating the chain of custody information using voice recognition apparatus.

Preferably, the method includes the step generating the chain of custody information by computer data entry.

Preferably, the method includes the step of recycling the RFID medium for subsequent use and erasing the chain of custody information from the RFID medium.

Preferably, the step of generating the chain of custody information includes generating demographic information specific to the donor.

Preferably the method includes the step of storing the collected sample and transport container for a predetermined time interval.

In a second aspect of the invention, a specimen and sample chain of custody tracking system is presented and includes means for collecting a desired sample from a donor at a collection site. Means are provided for placing the collected sample in a transport container uniquely identified by information in an RFID medium attached to the transport container. Means are provided for generating chain of custody information and means are provided for writing the chain of custody information to the RFID medium. Means are provided for reading the chain of custody information from the RFID medium at a sample testing site. Further means are provided for processing the collected sample in accordance with the sample testing site operating procedure. Means are provided for erasing the chain of custody information from the RFID medium.

Preferably, the system includes means for writing the donor's electronic signature to the RFID medium verifying the chain of custody information.

Preferably, the system includes means for writing the collector's electronic signature to the RFID medium.

Preferably, the system includes means for affixing the RFID medium to the transport container.

Preferably, the system includes means for providing tamper-evident detection means to the RFID medium.

Preferably, the system includes means for recycling the RFID medium for subsequent use and means for erasing the chain of custody information from the RFID medium.

### BRIEF DESCRIPTION OF THE DRAWINGS

Additional objects, features and benefits of the present invention will become readily apparent from the written description taken in conjunction with the drawings wherein:

FIG. 1 is a flow chart showing one embodiment of the method of the present invention for specimen and sample chain of custody tracking using RFID;

FIG. 2 is a flow chart showing another embodiment of the method of the present invention;

FIG. 3 is a flow chart showing a further embodiment of the method of the present invention for specimen and sample chain of custody tracking using RFID at a collection site;

FIG. 4 is flow chart showing a further embodiment of the method of the present invention for specimen and sample chain of custody tracking using RFID at a laboratory/testing facility;

FIG. 5 is a functional block diagram showing the fundamental components of a system for carrying out the method of the present invention.

FIG. 6 is a chart showing representative items that may be present in a typical chain of custody information form generated in the method of the present invention.

### DETAILED DESCRIPTION OF PREFERRED EMBODIMENTS

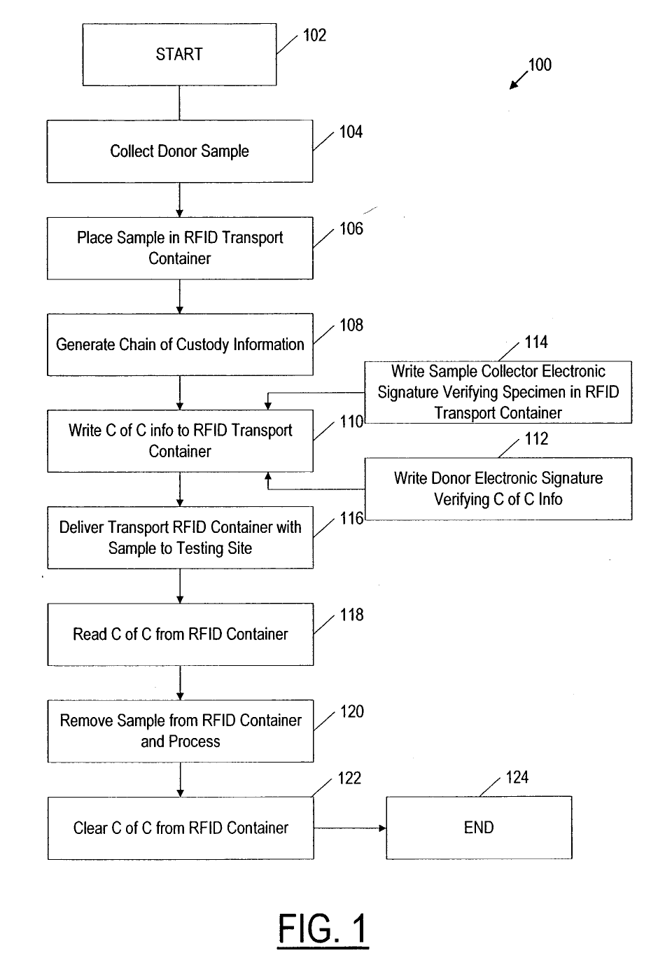

Turning now to the drawings and considering the invention in further detail, FIG. 1 is a flow chart showing one embodiment of the method of the present invention for specimen and sample chain of custody (COC) tracking in the medical, health and insurance industries using RFID medium for the storage of and retrieval from of COC information and is generally designated 100. Although the present invention is disclosed in the context of specimen and sample chain of custody tracking in the medical, health and insurance industries, the method and system of the present invention is not limited and may be employed in the chain of custody tracking of any item, thing or object outside these industries. The term “chain of custody” (COC) as used herein is not limited to any specific type or associated task but rather is generic and open-ended to include tracking of any item, thing or object. The RFID medium may be of any type and form factor now known or future developed to carry out the purpose of the invention.

The process or method begins at step 102 to start the sequence wherein a specimen or sample is collected from a donor as indicated in step 104. The collected sample specimen, typically a biological sample, is placed in an RFID transport container in step 106. The chain of custody (COC) information is generated in step 108 using a computer device capable of performing the associated tasks of data entry, display, processing and may be any of a number of well known computing devices such as a desk top or portable personal computer, personal digital assistant (PDA) or other hand held computing devices well known to those skilled in the art. Alternately the chain of custody (COC) information may be generated by voice recognition means coupled to the computing device. The COC information may be a combination of pre-entered data and data entered at the collection site location. A computer program or software package specifically designed to generate and display an electronic form representative of the chain of custody (COC) information to be input or collected is stored in the computing device to operate and control the processing means in the computing device. The software program is generally specific to each customer or donor and the sample specimen types being collected at the collection site. Once the chain of custody (COC) information is generated in step 108, it is transferred and electronically written to the RFID medium associated with the transport container in step 110. Optionally, the RFID medium may have pre-entered data for example, the identification of the transport container. The donor reviews and verifies the chain of custody (COC) information generated in step 108 and written to the RFID transport container in step 110, and attests to the validity and accuracy of the information by means of an electronic signature capture of the donor's signature in step 112. The donor's electronic signature is converted and written along with the chain of custody (COC) information to the RFID medium in step 110. Optionally, if desired, the identity of the sample collector can also be written to the RFID medium in step 110 by means of the electronic signature capture of the sample collector's signature in step 114 which is also written to the chain of custody (COC) information in the RFID medium in step 110 verifying the collected sample specimen in the RFID transport container. The RFID transport container holding the sample specimen and the chain of custody (COC) information written to the RFID medium is delivered to the testing or laboratory site in step 116. It is to be understood that the testing or laboratory site may be at the collection site. The chain of custody (COC) information is read from the RFID medium in step 118 and displayed for viewing by testing personnel in accordance with the testing laboratory standard operating procedures. The sample specimen is removed from the RFID transport container in step 120 and the sample specimen is processed in accordance with the laboratory standard operating procedure. The process now moves to step 122 wherein the chain of custody (COC) information is cleared from the RFID medium in the transport container and both the RFID medium and the transport container are processed in accordance with the standard operating procedure. The process stops at the end block 124.

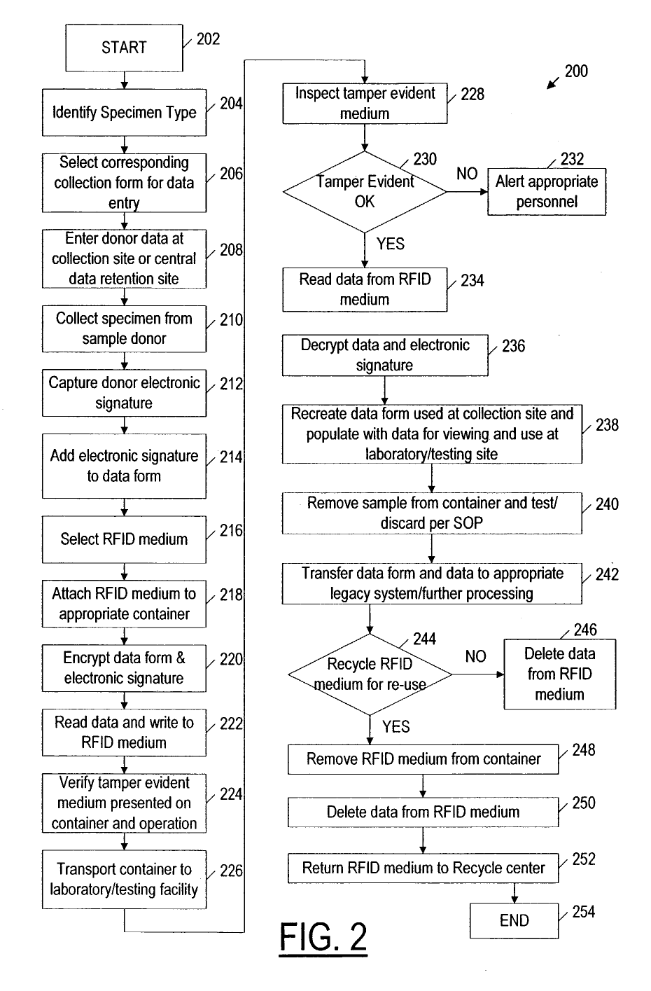

Turning now to FIG. 2, a flow chart showing another embodiment of the method of the present invention is illustrated therein and generally designated 200. The system process of the invention begins at the start step 202 to initialize the system and moves to step 204 wherein the specimen or sample type to be collected is identified by collection personnel. An electronic collection form corresponding to the specimen type identified in step 204 is selected and retrieved for display from a computing device for data entry in step 206. The donor's relevant information is entered at the collection site via data entry or voice recognition or retrieved from a central data retention site or as a combination of local data entry and retrieval in step 208 in accordance with the site's standard operating procedure. A sample specimen is collected from the donor and placed in the appropriate container in step 210. The donor's electronic signature is captured in step 212 and is added to the data of the electronic form with the entered or retrieved data in step 214. The appropriate RFID medium is selected in step 216 and attached to the appropriate container holding the sample specimen in step 218. The information in the electronic data form and the electronic signature are encrypted in step 220 for additional security and the encrypted data is read from the computer device and written to the RFID medium in step 222. A tamper-evident medium is added to the container and is verified to be present and operational in step 224. The container holding the sample specimen is transported to the laboratory/testing facility in step 226 and received in accordance with the facility's standard operating procedure. The tamper-evident medium is inspected in step 228 for any evidence of tampering or intrusion which may potentially affect the validity of the sample specimen in the container. If the tamper-evident medium is determined not to be OK in step 230, then the appropriate personnel are alerted in step 232 and further action in accordance with the standard operating procedure is taken. If the tamper-evident medium is determined to be OK in step 230, the information stored or contained in the RFID medium is read in step 234 using an appropriate RFID medium reader. This information is then transferred to the computing device. The data and electronic signature read from the RFID medium is decrypted in step 236 by the computing device. The electronic data form used at the collection site is recreated and populated with the various data fields for viewing and use at the laboratory/testing site in step 238. The sample specimen is removed from the container in step 240 and tested and/or discarded in accordance with the standard operating procedure used at the laboratory/testing site. The data acquired in steps 238 and 240 are transferred in step 242 to an appropriate legacy system for further processing or archiving. It is next determined in step 244 whether the RFID medium is to be recycled for reuse and if not, then the data is deleted from the RFID medium in step 246 and the container and RFID medium are then handled in accordance with the standard operating procedure which may include the destruction of both. If in step 244 it is decided to recycle the RFID medium for reuse, the RFID medium is removed from the container in step 248 and the data is deleted from the RFID medium in step 250. Once the separated RFID medium has the data deleted from it, it is returned to the recycle center in step 252 and the process ends at the end step 254. It should be noted that the RFID medium is sanitized prior to re-use in accordance with suitable sanitizing agents and processes well known to those skilled in the art. The ability to re-use the RFID medium for multiple collections in the method and system for the invention provides an economic savings because a new RFID medium is not required for each new collection. The tamper-evident medium may be of any type now known or future developed and for example, may be tape to seal the container or may be shrink-wrap to affix the RFID medium to the container both of which provide visible evidence if tampered with. Also, containers specifically designed with tamper-evident indicator mechanisms are also contemplated for use with the present invention.

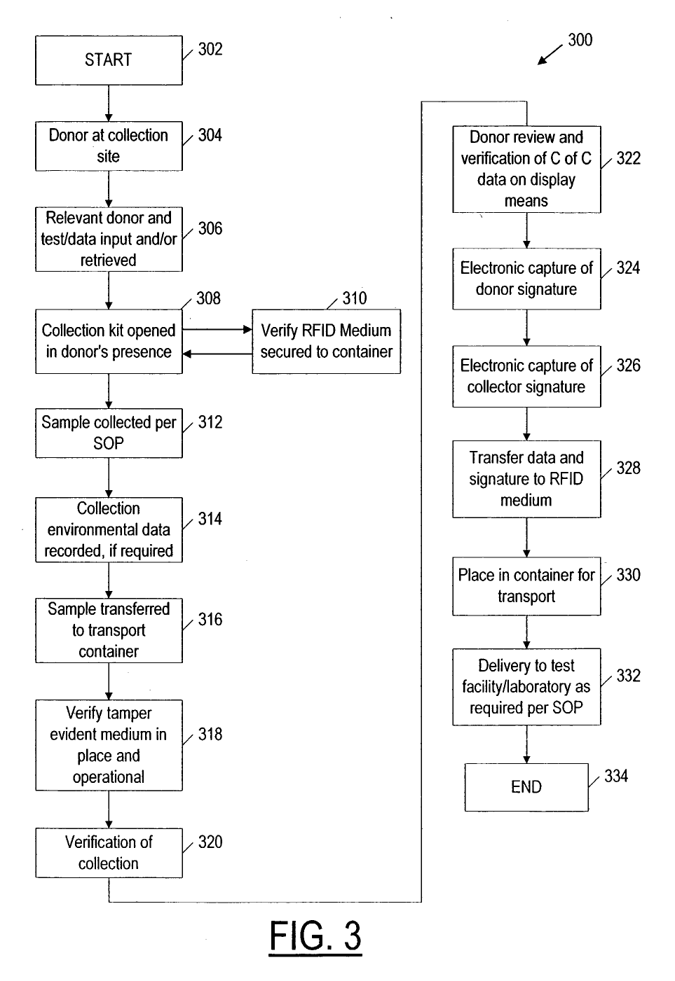

Turning now to FIG. 3, a flow chart showing a further embodiment of the method of the present invention for specimen and sample chain of custody tracking using RFID at a collection site is illustrated therein and generally designated 300. The method illustrated in the flow chart 300 is typical as might be found for urine testing drugs of abuse and begins with the start block 302. A donor presents himself/herself at a collection site in step 304 and the relevant donor and test data are input to the system and/or are retrieved from other sources containing the required information in step 306. A collection kit containing the specimen sample container, RFID medium, tamper-evident medium, and other items which may make up the collection kit is opened in the presence of the donor in step 308. The RFID medium is verified also in the donor's presence to be secured to the transport container in step 310. The sample specimen is collected in accordance with the standard operating procedure in step 312. Additional environmental data is recorded, if required, such as temperature, humidity or other such data in step 314. The specimen sample is transferred to the transport container in step 316 and the tamper-evident medium is verified to be in place and operational in step 318. The specimen collector personnel verifies the collection of the sample specimen in 320 and the donor reviews and verifies the chain of custody (COC) information data displayed on the display means in step 322. If all is in order, the electronic signature of the donor is captured in step 324 attesting to the validity and accuracy of the chain of custody (COC) information displayed in step 322. The electronic signature of the collector is captured in step 326 attesting to the verification of the collection in step 320. All the data from the chain of custody information electronic form in the computing device along with the electronic signatures are transferred to the RFID medium in step 328. The sample specimen container with the RFID medium and tamper-evident medium in place is put in a transport device or other suitable means now known or future developed in step 330 for delivery to a test facility/laboratory as required in accordance with the standard operating procedure in step 332. The process ends with the end block 334.

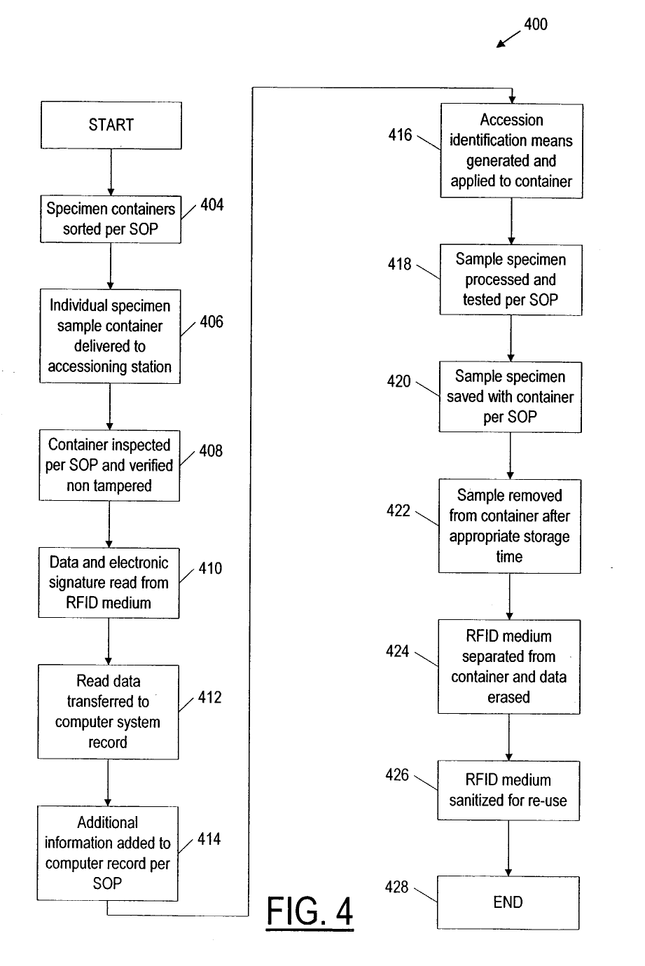

Turning now to FIG. 4, a flow chart showing a further embodiment of the method of the present invention for specimen and sample chain of custody tracking using RFID at a laboratory/testing facility is illustrated therein and generally designated 400. The laboratory/testing facility may typically receive specimen samples for testing such as the urine testing drugs of abuse sample specimens collected at a collection site as represented by the flow chart of FIG. 3. The process at the laboratory/testing facility begins at the start step 402 wherein the specimen sample containers received are sorted in accordance with the standard operating procedure at the laboratory in step 404. Individual specimen sample containers are delivered one at a time to a corresponding station for accessioning in step 406. The container is inspected in accordance with the standard operating procedure and is verified to be non-tampered in step 408. The information data and electronic signatures are read from the RFID medium in step 410 and transferred to a computer system record in step 412. The computer system record may be shown on a display means for use by the laboratory personnel and additional information, if any, may be added to the computer record by means of a data entry device in accordance with standard operating procedures in step 414. Accession identification means are generated and applied to the sample container in step 416. The generation and use of accession identification means is well known to those skilled in the art. The sample specimen is processed and tested in accordance with standard operating procedures in step 418. The remaining sample specimen is saved and stored with the container in accordance with the standard operating procedure for an appropriate period of time in step 420. The storage time period may be set by regulatory agencies, statutes both state and federal, type of sample specimen, or other directives now known or future invoked. During the storage time period, the RFID medium may be read to ascertain the specifics of the stored sample. After the appropriate storage time period passes, the specimen sample is removed from the container in step 422. The RFID medium is separated from the container and the data is erased from the RFID medium in step 424. The RFID medium is next sanitized in step 426 for reuse at a later date. The process stops at the end block 428.

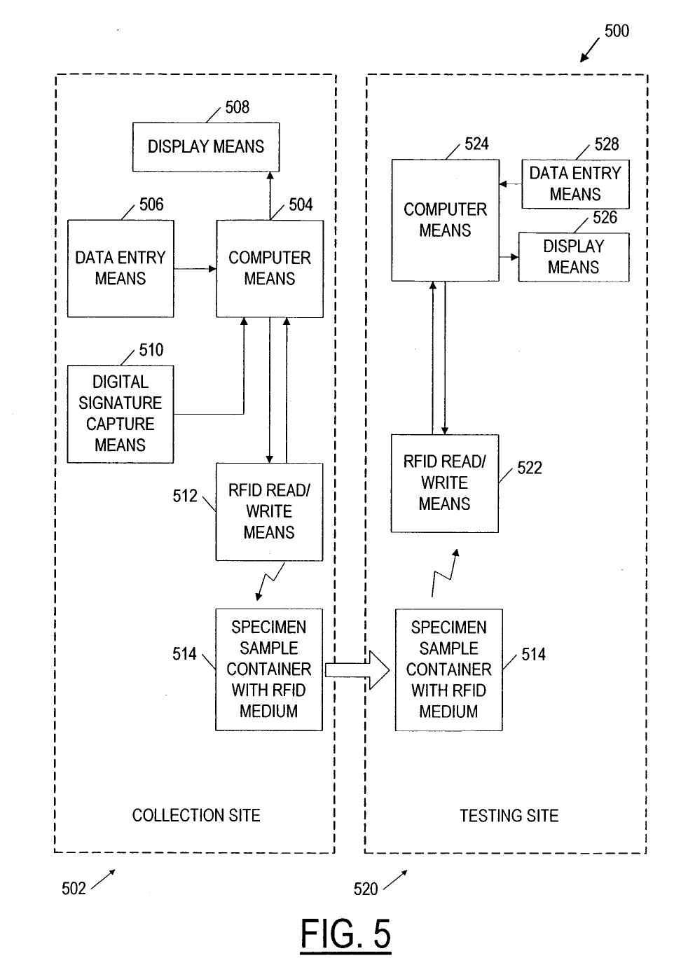

Turning now to FIG. 5, a functional block diagram showing the fundamental components of a system for carrying out the method of the present invention for specimen and sample chain of custody tracking using RFID technology is illustrated therein and generally designated 500. A collection site shown in the dash line box 502, includes computer means 504 having a memory for storing an appropriate software program for controlling the operation of the system and having processing means for carrying out the various required operations and computational tasks. A data entry means 506 is coupled to the computer means 504 to enter data in an alpha/numeric format to appropriate corresponding data fields in the chain of custody information electronic form presented on the display means 508 coupled to the computer means 504. A digital signature capture means or signature pad 510 generally well know to those skilled in the art is coupled to the computer means 504 and is used to capture the signature of the donor, collector, or other personnel as required in accordance with the specific established requirements specified by local, state, federal or other health in regulatory agencies. An RFID read/write device means 512 is coupled to the computer means 504 to receive and send information in a bi-directional manner to and from the computer means. Data in an encrypted or unencrypted form is received from the computer means 504 and is transferred to the RFID medium on a specimen sample container generally designated 514. Preferably, the data is encrypted for additional security and privacy of information. Reading and writing data to and from an RFID medium is well understood in the art and may take on any form in accordance with the particular RFID medium utilized. The specimen sample container with the RFID medium is transported to a testing site generally designated within the dash line box 520. The information carried by the RFID medium in the specimen sample container is read by an RFID read/write device means 522 in accordance with the specific RFID medium utilized and is well understood to those skilled in the art. The RFID read/write device means 522 is coupled to a computer means 524 and information is read to and from the RFID read/write device means 522 and the computer means 524 in a bi-directional manner. Processing means within the computer means 524 carries out the operational steps of the software program to decrypt the data to recreate the chain of custody electronic data information form and other information including the donor information, specific tests to be performed, and any other information that is relevant to the task at hand. The information is shown on a display means 526 coupled to the computer means 524. A data entry means 528 is coupled to the computer means 524 and is utilized to add any additional information to the displayed chain of custody electronic data form or computer record as required.

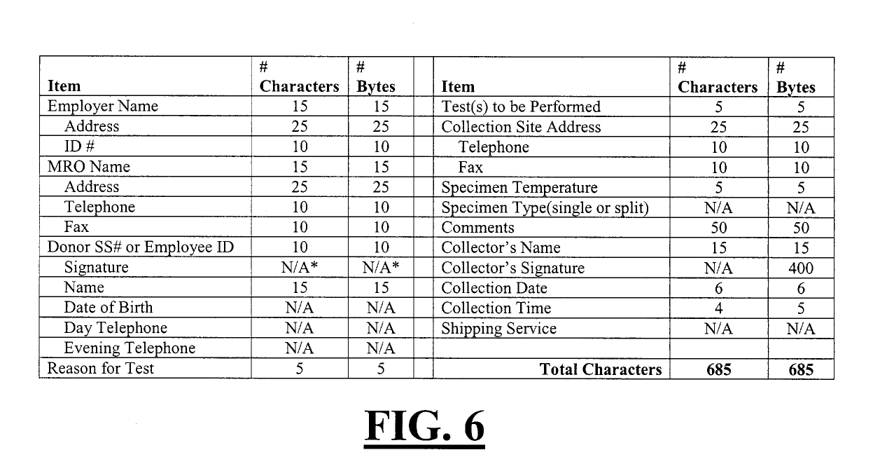

Turning now to FIG. 6, a chart showing representative items that may be present in a typical chain of custody electronic information data form generated in the method of the present invention and carried by the RFID medium secured to the sample specimen container is illustrated therein. It is to be understood that the items presented are typical and not inclusive of all the required information. For example, it may be desirable to provide information relative to any insurance carrier that the donor or employer may have. Additional information may include the name of the personnel transporting the sample container from the collection site to the laboratory testing site or other relevant information as required. The ability to read and write information from and to the RFID medium makes the present invention flexible and substantially non-limiting as to the data that may be captured as part of the chain of custody tracking of sample specimens.

The sample specimen or transport containers may be provided with access that can only be gained by producing visible evidence that the container has been opened whether by accident or on purpose. Typical tamper-evident means for providing visible evidence includes the use of tape or a seal, or containers that are specifically designed to include a visible evidence of tamper indication that the container has been opened and such containers are well known to those skilled in the art. The integrity of the sample specimen carried in the container is becoming increasingly important for drug testing and other human disease type testing wherein the security and donor confidentiality of the information is required. It is important to insure that the “guarantee chain of custody” of the container contents by providing a tamper-evident seal to the container to protect it from being opened by unauthorized personnel who might potentially tamper with the contents.

Although the above embodiment of the chain of custody specimen sample tracking system has been described as a stand-alone system, it is contemplated that the method of the invention can be integrated with other related systems such as for example, testing and diagnostic pre-approval and authorization, reimbursement, classification, regulatory tracking and other such medical and health care billing systems now in use or future developed.

A method and associated system for chain of custody (COC) specimen and sample tracking in a wireless and paperless environment has been disclosed above in several preferred embodiments. Numerous changes and modifications may be made by those skilled in the art and therefore the invention has been disclosed by way of example rather than limitation.

What is claimed is:

1. Method for specimen and sample chain of custody tracking comprising the steps of:
collecting a desired sample from a donor at a collection site;
placing the collected sample in a transport container uniquely identified by information in an RFID medium;
generating chain of custody information;
writing chain of custody information to the RFID medium;
reading chain of custody information from the RFID medium at a sample testing site;
processing the collected sample in accordance with the sample testing site operating procedures; and
erasing the chain of custody information from the RFID medium.

2. The method of claim 1, wherein the step of writing chain of custody information includes the step of writing the donor's electronic signature to the RFID medium verifying the chain of custody information.

3. The method of claim 1, wherein the step of writing chain of custody information includes the step of writing the collector's electronic signature to the RFID medium.

4. The method of claim 1, further including the step of affixing the RFID medium to the transport container.

5. The method of claim 1, further including the step of providing a tamper-evident detection means to the RFID medium.

6. The method of claim 1, further including the step of generating the chain of custody information using voice recognition apparatus.

7. The method of claim 1, further including the step of generating the chain of custody information by computer data entry.

8. The method of claim 1, further including the step of recycling the RFID medium for subsequent use and erasing the chain of custody information from the RFID medium.

9. The method of claim 1, wherein the step of generating the chain of custody information includes generating demographic information specific to the donor.

10. The method of claim 1, further including the step of storing the collected sample and transport container for a predetermined time interval.

11. A specimen and sample chain of custody tracking system comprising:
means for collecting a desired sample from a donor at a collection site;
means for placing the collected sample in a transport container uniquely identified by information in an RFID medium;
means for generating chain of custody information;
means for writing chain of custody information to the RFID medium;
means for reading the chain of custody information from the RFID medium at a sample testing site;
means for processing the collected sample in accordance with the sample testing site operating procedures; and
means for erasing the chain of custody information from the RFID medium.

12. The specimen and sample chain of custody tracking system as defined in claim 11 further including means for writing the donor's electronic signature to the RFID medium verifying the chain of custody information.

13. The specimen and sample chain of custody tracking system as defined in claim 11 further including means for writing the collector's electronic signature to the RFID medium.

14. The specimen and sample chain of custody tracking system as defined in claim 11 further including means for affixing the RFID medium to the transport container.

15. The specimen and sample chain of custody tracking system as defined in claim 11 further including means for providing tamper-evident detection means to the RFID medium.

16. The specimen and sample chain of custody tracking system as defined in claim 11 further including means for recycling the RFID medium for subsequent use and means for erasing the chain of custody information from the RFID medium.

17. Method for specimen and sample chain of custody tracking comprising the steps of:
providing relevant donor information and testing information at a collection site;
opening a collection kit in the presence of the donor;
verifying the RFID medium is secured to the transport container in the collection kit;
collecting a desired sample specimen from the donor in accordance with the testing information;
placing the collected sample specimen in the transport container uniquely identified by information in the RFID medium;
verifying tamper-evident medium in place on the transport container and operating;
verifying the sample specimen collection and capturing the electronic signature of the collector;
reviewing and verifying the donor information and testing information and capturing the electronic signature of the donor;
writing the donor information, testing information, and donor and collector electronic signatures to the RFID medium;
inspecting the transport container and tamper-evident medium at a sample testing site;
reading the donor information, testing information and electronic signatures of the donor and collector attesting the integrity of the donor information and collected sample specimen;
generating accession identification means and applying to transport container;
processing the collected sample specimen in accordance with sample testing site operating procedures;
saving the transport container with the collected sample specimen for a predetermined time interval;
removing the collected sample specimen from the transport container after the predetermined time interval has passed;
separating the RFID medium from the transport container;
erasing information contained in the RFID medium;
sanitizing the RFID medium for re-use.
